(19) United States
(12) Patent Application Publication
(10) Pub. No.: US 2002/0125967 A1
(43) Pub. Date: Sep. 12, 2002

(54) Air dielectric backplane interconnection system

(76) Inventors: Richard H. Garrett, Camp Hill, PA (US); Richard A. Elco, Mechanicsburg, PA (US); Timothy A. Lemke, Dillsburg, PA (US)

Correspondence Address: Woodcock Washburn LLP, 46th Floor, One Liberty Place, Philadelphia, PA, 19103, US

(21) Appl. No.: 10/015,985

(22) Filed: Nov. 2, 2001

Related U.S. Application Data
(60) Provisional application No. 60/245,617, filed on Nov. 3, 2000.

(51) Int. Cl. H01P 5/02

(52) U.S. Cl. 333/1; 333/33

(57) ABSTRACT

An air dielectric backplane interconnection system is disclosed. The interconnection system disclosed is a high speed backplane interconnection system having a plurality of conductor matched impedance transmission line elements and an air dielectric surrounding the plurality of transmission line elements. An interconnection system also having spacers disposed between the transmission line elements and a ground plate is disclosed.

### CROSS REFERENCE TO RELATED APPLICATIONS

This application claims the benefit under 35 U.S.C. § 119(e) to U.S. Provisional Patent Application No. 60/245,617 filed on Nov. 3, 2000.

### FIELD OF THE INVENTION

The present invention relates to electrical connectors. More particularly, the present invention relates to high speed, matched impedance backplane interconnection systems.

### BACKGROUND OF THE INVENTION

The dominant theme in the development of electronics hardware for both the computer and telecommunications markets is increased bandwidth. The demand for more bandwidth comes from the opposite ends of the datacom and telecom hierarchy-the microprocessor and the needs of the global telecommunications network-driven by the explosive growth of the Internet.

With bandwidth requirements exceeding 10 Gb/s, both standard printed circuit boards and their associated connectors have reached a performance barrier. Performance in the context of the present invention is the ability to correctly read or interpret signals. Performance determinations have been made by generating so called “eye patterns”. Assuming a standard 19 inch rack mounted system, the accepted value for the maximum practical bandwidth and standard connector configurations is about 2.5 Gb/s. The maximum theoretical bandwidth using state-of-the-art material and connector designs is about 6 Gb/s. Beyond 5 Gb/s, fiber optics, cabling and alternative new technologies such as waveguides are being considered as possible solutions.

Cabling, using high speed materials such as foamed fluorocarbons in transmission line or coaxial cable configurations, is a potential means for high speed transmission. However, cables are relatively high in cost, and in addition, most termination techniques can introduce significant signal discontinuities in high speed applications. Furthermore, foamed cables with low dielectric constants are inherently unstable and dimensional control is difficult to achieve economically, particularly with miniaturized designs.

Dielectric losses of insulators used in printed circuit board constructions also cause significant signal losses in high frequencies applications. Even specialized materials such as fluorocarbons have high losses in these applications.

Another source of loss in high speed circuit boards is resistive losses. Conventional printed circuit boards using relatively thin foils, however, limit the potential speed of the circuit boards. On the other hand, increasing the thickness of the copper foils limits the circuit density of the boards or the width and pitch of the etchings in the circuitry. Furthermore, since most of the loss is “skin-effect” related, increasing the width of the conductor has a greater effect on transmission losses than just increasing the thickness.

One method of minimizing conductive losses would be to use rectangular or round conductors assembled into a circuit. If conductive “wires” are used rather than etched foil, the geometry can be designed to optimize the performance and circuit density. Round conductors are advantageous because they are readily available, compatible with conventional equipment, and do not require high cost tooling to fabricate. However, in order to optimize the performance of round conductors, dielectric losses should also be minimized. Since air has a dielectric constant of 1, air dielectric transmission lines could be extremely useful in transmitting high frequency, high bandwidth signals across a printed circuit board.

There is a need, therefore, for a low cost, high tolerance connector system that transmits high frequency, high bandwidth signals over wire transmission lines having an air dielectric.

### BRIEF SUMMARY OF THE INVENTION

The present invention satisfies the aforementioned need by providing systems and methods for constructing an interconnection system using transmission line elements having an air dielectric to achieve the transmission of high frequency, high bandwidth signals between two electrical systems. The air dielectric backplane interconnection system of the present invention is used to connect backplane connectors or circuit boards to other circuit boards, such as, for example, daughter boards or the like.

In one embodiment of the present invention, a high speed backplane interconnection system comprises a plurality of conductor matched impedance transmission line elements and an air dielectric surrounding the plurality of transmission line elements. In another embodiment of the present invention, the system includes a ground plate disposed a predetermined distance from the transmission line elements. For example, spacers are used to dispose the transmission line elements a predetermined distance thereby creating a predetermined characteristic impedance of the interconnection system.

### BRIEF DESCRIPTION OF THE SEVERAL VIEWS OF THE DRAWING

Other features of the present invention are further apparent from the following detailed description of the embodiments of the present invention taken in conjunction with the accompanying drawings, of which:

FIG. 1 is a top view of an interconnection system in accordance with the present invention;

FIG. 2 is a side view of the interconnection system of FIG. 1;

FIG. 3 is a front view of the conductors and spacer elements as used in the interconnection system of the present invention;

FIG. 4 is a top view of a ground plate as used in one embodiment of the present invention; and

FIG. 5 is a block diagram of several interconnection systems of the present invention as used with various other electrical systems.

### DETAILED DESCRIPTION OF THE INVENTION

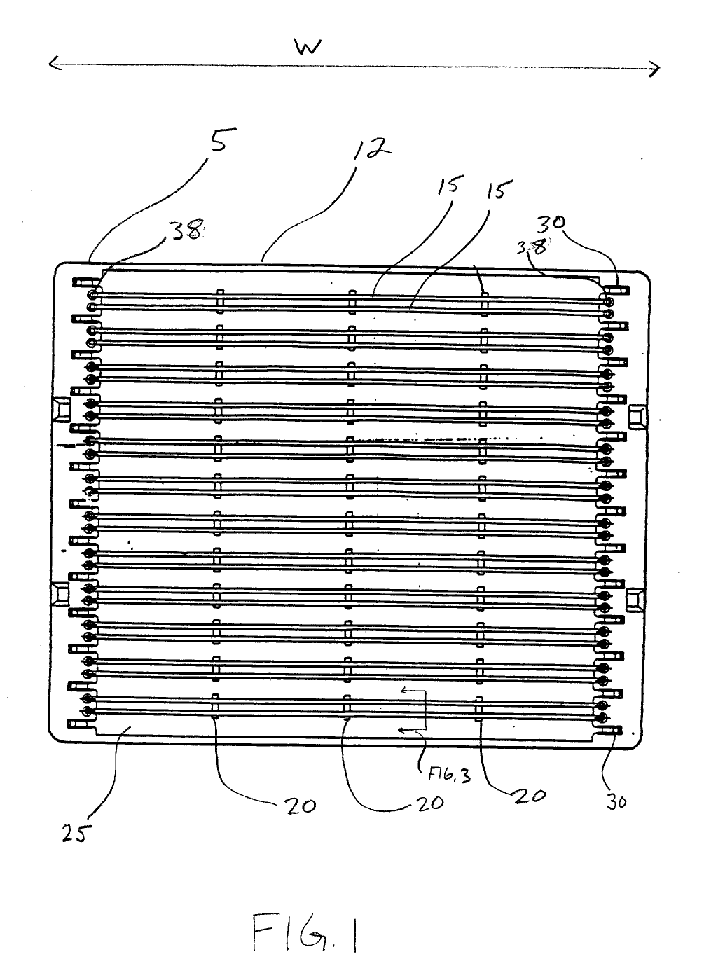

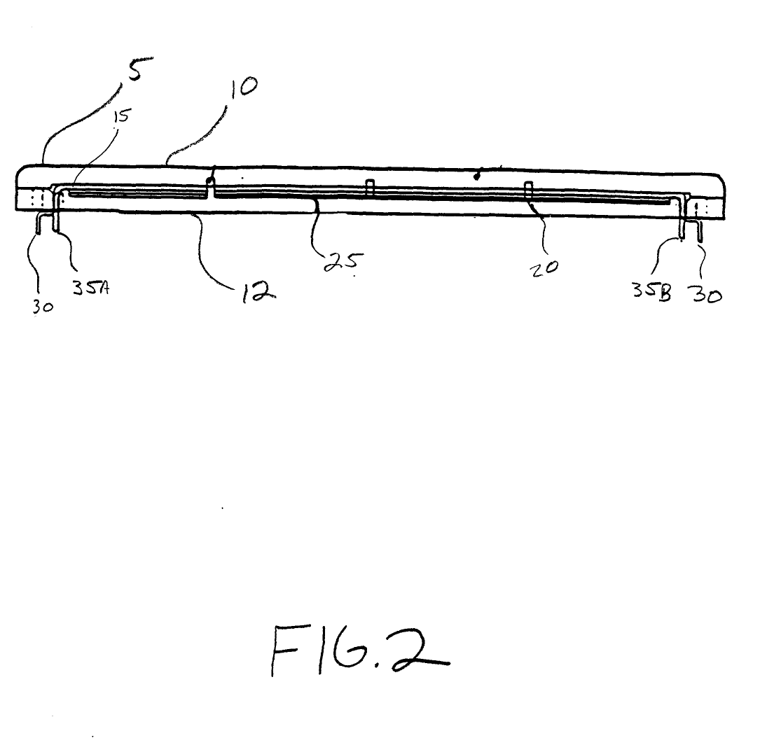

FIGS. 1 and 2 are top and side views, respectively, of an interconnection system in accordance with one embodiment of the present invention. The high speed backplane interconnection system 5 includes two planes or plates 10, 12 with wire conductors or transmission lines 15 suspended therebetween. In a preferred embodiment, the two plates 10, 12 are formed from a non-conductive material. The transmission lines 15 are also connected to signal tabs 35A and 35B through apertures 38 in plate 12. Signal tabs 35A and 35B are then each connected to separate electrical systems (not shown) to electrically interconnect them via the transmission lines 15.

For example, the wire or filament conductors 15 may be manufactured using a conventional extrusion process, i.e. where the material is forced through a precisely formed die opening. The tolerances of extruded wires 15 are typically held to tenths of thousandths of an inch.

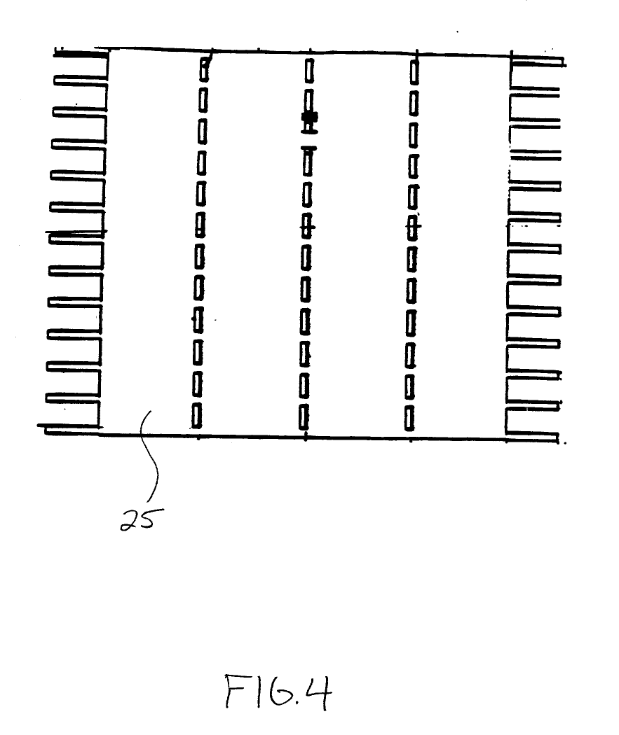

The system 5 also includes a ground plate 25 (shown in isolation in FIG. 4) connected to ground tabs 30. The distance between the plate 25 and the conductors 15 determines the characteristic impedance of the transmission line system 5. Consequently, varying the distance between the ground plate 25 and the conductor 15 varies the characteristic impedance of the system. Typically, the impedance needs to be controlled to within 10% to prevent unwanted signal reflections. At the scale required for circuit boards, it is necessary to control the space between the plates or planes and the conductors to several thousandths of an inch.

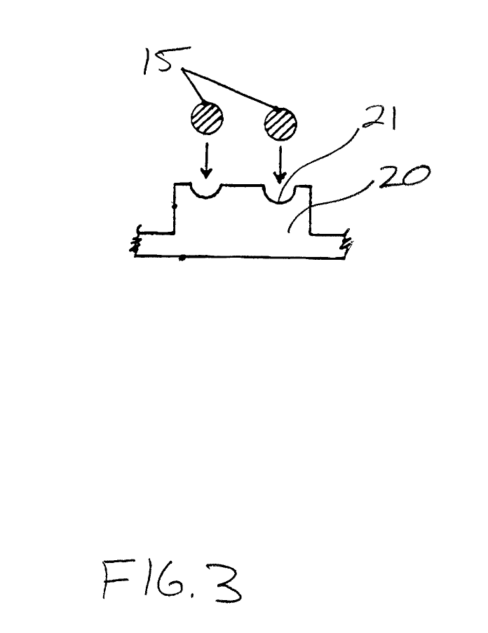

In order to maintain a predetermined distance between the line elements and the plates, spacers 20 are disposed between the signal conductors 15 and the ground plate 25. FIG. 3 is a cross sectional view of the conductors and spacer elements as used in the interconnection system of the present invention in FIG. 1. As shown, spacer 20 is formed to include grooves 21 for securing conductors 15 at a predetermined distance from the ground plate 25.

In one embodiment of the present invention, the spacers are made of a polymer monofilament, however, other materials may be used without departing from the scope of the present invention. Typically the spacers or filaments are placed on a 0.250″ pitch and have a negligible effect on the characteristic impedance or the high speed transmission characteristics of the transmission line.

In one embodiment of the present invention, the spacers 20 are stitched into holes in the ground plate 25. Other configurations, such as gluing or molding the spacers to the ground plate 25 could be used without departing from the scope of the present invention.

In another embodiment of the present invention, external to the spacer matrix, larger conductors (not shown) are used to establish the overall structural spacing of the ground plates. For example, in the system described, a 22 AWG conductor (with a diameter of 0.025″) is placed on either side of a group of conductors to provide structural spacing for the system. The 22 AWG conductor may be bonded or soldered to the ground structures. This configuration is particularly useful in systems where power transmission is required throughout the backplane system. It is advantageous to have the power conductors closely coupled to the ground system, but electrically isolated to provide a capacitively coupled power system. Such a configuration may be integrated into the above described system by using a magnet wire, either round, square, or rectangular, of the appropriate dimensions to provide both a mechanical spacer for the transmission line system and a power distribution system.

In another embodiment of the present invention, the transmission line conductors are cut into discrete lengths and the ends bent at right angles to form staple like elements. The middle section of the staple would be determined by the link length and the short legs by the thickness of the PCB to which the link is to be mounted. The short legs of the “staple” would be inserted into holes in a thin PCB that would serve as the bottom shield of the link. The shield layer around the leads is etched away in the areas where the signal lines extend through the bard and the ground lines are soldered directly to the shield. The wire staples are then inserted over the spacers to provide the appropriate spacing for the impedance matched system. The upper shield layer would have additional filament spacers and would be assembled on top of the transmission line conductors. Furthermore, in this embodiment, the outer conductors of the link could consist of larger ground or capacitively coupled power conductors as previously discussed. The upper shield could be a thin printed circuit board similar to the bottom board, or could alternatively be a relatively thin sheet metal structure. The two shields are mechanically fastened to one another using a variety of fasteners. Some of the mechanical structures that might be used in the system design are extrusions with end caps, plastic molded frame, die cast frame, or screws or rivets with spacers.

In another embodiment, the links are surface mountable. In this manner, the tabs or solder tails 35A and 35B are bent such that they extend in the same plane as the link after insertion through the printed circuit board. Alternatively, the leads could extend in a co-planar manner through spacers and would be formed so that they would be co-planar to the link but be able to contact the printed circuit board surface.

In another embodiment of the present invention, alternative to the printed circuit base structure, a relatively thin sheet metal stamping is used having holes or slots stamped in the area where the leads are to protrude. A plastic molding with holes corresponding to the centers of the transmission line conductors is then press-fit through the holes in the stamping. In addition, the spacers may be part of the molding, eliminating the need for separate parts and assembly operations. Such spacers also include grooves to secure the conductors and the top cover is assembled to the base. The cover is designed to precisely clamp the conductors in place.

The clamping areas and transitions through the system are carefully designed to have controlled impedance throughout the structure and in the printed circuit board transition. In this manner, the printed circuit transition is carefully designed and the impedance is controlled by careful spacing of the centerlines of the ground and signal conductors through the system and in the printed circuit transition.

In another embodiment, the ground conductors are eliminated and the grounds are terminated by extensions of the ground planes by means of thin metal tabs 30 (FIG. 1) that project through the housing and are soldered into holes or pads on the printed circuit board. Again, this can cause a slight reduction in the transmission line performance that is offset by the significant cost reduction that can be a result of eliminating about ⅓ of the conductors that are normally used.

In another embodiment of the present invention, the transmission lines are continuous over the length of the backplane. In this regard, the spacers are again molded to include slots to accept the conductors on the required pitch and are placed on the transmission line conductors at the same spacing as required by the connectors, generally 0.75″ to 2″, with 1.5″ being typical. These spacers may be molded separately and assembled to the transmission line conductors, or preferably are molded in a continuous molding operation and reeled in continuous length. The transmission lines are then cut to length and the molded spacers are aligned with slots or grooves in the ground structure. Openings are present to allow for connectorization of the backplane assembly. The connector system can also have contacts with slots that are press fit over the conductors to make an electrical connection to the conductors of the transmission lines. In this manner, the body of the connector can be at a right angle to the backplane and designed to accept daughter cards.

The connectors would require care in design to maintain impedance control and grounding throughout the transmission line pathway. In addition, if the design has slots in the ground plane structure, ground lines are incorporated onto the transmission line structure so that the gaps in the ground structure can be bridged. If care is not taken in the connector design, a high impedance discontinuity spike might occur as a result of having a gap in the ground plane at the area of the slot. This concept would require a special connector design.

In another embodiment of the present invention, the transmission lines are a series of discrete links, rather than continuous transmission lines with openings in the ground plane structure. In this regard, the links are interconnected by short pad areas on the printed circuit board that either have associated holes or surface mount pads terminating the system of the present invention. Pads and terminations are designed to minimize potential impedance discontinuities and shield interruptions. In addition, connectors for daughter cards are mounted either between the links or on the opposite side of the board. In this case, conventional connectors may be utilized in the system, although optimum results are obtained with custom connector designs.

The elements between the links and the connectors connected to a system of the present invention may vary without departing from the scope of the present invention. For example, the configuration may be user dependant.

In one embodiment of the present invention, the interconnection system of the present invention has an overall width W of 40 mm. The system width may vary without departing from the present invention. System widths over 2 inches (50 mm) may be used, however, such larger dimensions may cause difficulties in manufacturing the parts to sufficiently tight tolerances. Furthermore, the reliability of standard surface mount techniques tends to decrease as 2″ is approached. Furthermore, the system can include any number of channels per system with 12 (0.050″ pitch) to 16 (1 mm pitch) channels per system preferred.

Additionally, in one embodiment of the present invention, the conductors 15 of the interconnection system are 28 AWG round conductors with a diameter of 0.0126″ with a pitch of 0.050″. In this regard, in order to fabricate an air dielectric system with a characteristic impedance of 100 ohms in differential mode, a 0.010″ air gap between the conductor and the ground plate is required over the entire length of the transmission line. In this embodiment, the 0.010″ air gap is established using polymer monofilaments of 0.010″ diameter oriented at right angles to the transmission lines.

In another embodiment of the present invention, the system has a channel density of 3 mm with individual conductors on 1 mm centers. The channel density may vary, however, without departing from the scope of the present invention. For example, multi-layer designs (with each layer having a corresponding ground and signal row) with higher circuit density can be designed and constructed with any number of layers.

For example, in a 2-layer system having a channel density of 1.5 mm, two different heights of “staples” would be used for a lower and upper transmission layer. In a multi-layer design, the conductors are arranged relative to each other with the centers of the conductors staggered so that the net conductor pitch of the two rows would be half the pitch of the conductors on each layer. For example, if the pitch on an individual layer is 0.050″, the net pitch of two layers would be 0.025″. The conductors exit the system through a hole pattern of 0.050″ with staggered rows to maximize the space between the holes so that the trace width is optimized.

Although a number of connectors could be used with the system of the present invention, preferably the connector system has the same pitch as the transmission line system with the same number of rows as layers in the system. For example, a connector for a system with two layers on 0.050″ pitch would be a two row connector on 0.050″ spacing. This would minimize the variation in line lengths that can induce jitter and changes in line geometry, which may result in impedance discontinuities. In one embodiment, the connector is a surface mount leaded device to minimize discontinuities. Press fit connectors, however, can also be used without departing from the present invention.

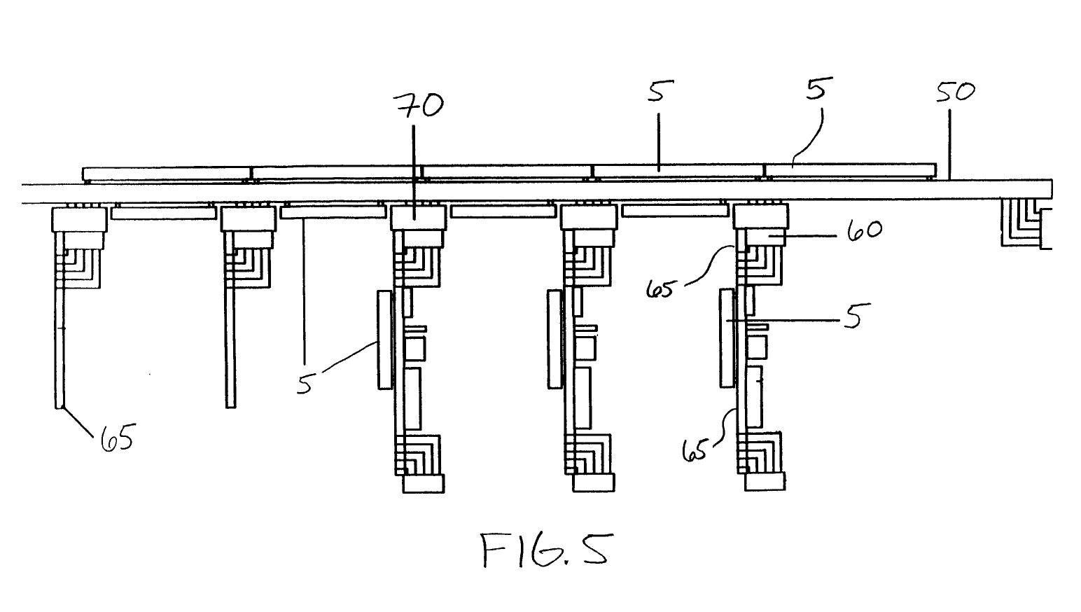

FIG. 5 is a block diagram of several interconnection systems of the present invention as used with various other electrical systems. As shown, the interconnection system of the present invention may be used in a variety of contexts. For example, the interconnection system 5 of the present invention is used to connect to two portions of the backplane 50. Additionally, the interconnection system 5 of the present invention is used to connect two daughtercards 65 connected to the backplane 5 by way of a daughtercard connector 60.

As the foregoing illustrates, the present invention is directed to an air dielectric backplane interconnection system. It is understood that changes may be made to the embodiments described above without departing from the broad inventive concepts thereof. For example, the channel density of the interconnection system may vary without departing from the scope of the present invention. Accordingly, the present invention is not limited to the particular embodiments disclosed, but is intended to cover all modifications that are within the scope of the present invention, as defined by the appended claims.

What is claimed is:

1. A high speed backplane interconnection system comprising:
a plurality of conductor matched impedance transmission line elements; and
an air dielectric surrounding the plurality of transmission line elements.

2. The interconnection system of claim 1, further comprising:
a ground plate disposed a predetermined distance from the transmission line elements wherein the predetermined distance is reflective of a characteristic impedance of the system.

3. The interconnection system of claim 1, further comprising:
a base plate; and
a plurality of spacers positioned on said base plate for securing the transmission line elements a predetermined distance from said base plate.

4. The interconnection system of claim 3, wherein the spacers are formed from a nonconductive material.

5. The interconnection system of claim 1, further comprising:
a housing surrounding the transmission line elements.

6. The interconnection system of claim 5, wherein the housing comprises:
a cover; and
a base adapted to securely receive the cover.

7. The interconnection system of claim 6, wherein the cover and the base are formed from a non-conductive material.

8. The interconnection system of claim 1, further comprising:
a plurality of signal tabs, each signal tab connected to an end of each transmission line and also adapted to be connected to an electrical system such that when the signal tab is connected to the electrical system an electrical connection is established between the transmission line and the electrical system.

9. The interconnection system of claim 2, further comprising:
at least one ground tab connected to the ground plate for connecting the ground plate to a ground.

10. The interconnection system of claim 1, wherein the transmission line elements have a round cross-section.

11. An electrical system comprising:
a backplane; and
a high speed interconnection system disposed on said backplane, the interconnection system comprising:
a plurality of conductor matched impedance transmission line elements; and
an air dielectric surrounding the plurality of transmission line elements.
